(19) United States
(12) Patent Application Publication
(10) Pub. No.: US 2003/0096579 A1
(43) Pub. Date: May 22, 2003

(54) Wireless communication system

(75) Inventors: Takumi Ito, Tokyo (JP); Akihisa Ushirokawa, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/300,773

(22) Filed: Nov. 21, 2002

(30) Foreign Application Priority Data
Nov. 22, 2001 (JP) 2001-356896

(51) Int. Cl. H04B 17/00; H04Q 7/20; H04B 7/00

(52) U.S. Cl. 455/67.1; 455/525; 455/423; 455/424

(57) ABSTRACT

It is sought to permit communication distance increase, interference power reduction and hardware scale increase suppression.

It is made possible to increase the communication distance by selecting sub-carriers according to the line quality. In the case of the multiple cell construction, by selecting sub-carriers according to the line capacity it is made possible to reduce the interference power and realize communication, in which all cells use the same frequency band. In this case, it is possible to suppress hardware scale increase that is the case in the prior art techniques.

### BACKGROUND OF THE INVENTION

This application claims benefit of Japanese Patent Application No. 2001-356896 filed on Nov. 22, 2001, the contents of which are incorporated by the reference.

The present invention relates to wireless communication systems, for instance, wireless communication system, in which transmission parameters are adaptively controlled based on the line quality.

Prior art techniques concerning multiple-carrier wireless communication systems adopted in mobile communication and the like, are disclosed in, for instance, Japanese Patent Laid-Open No. 2001-28577 entitled “Communication Systems among Vehicles on Roads and Communication Station on Road and Vehicle-Mounted Mobile Stations”, Japanese Patent Laid-Open No. 2001-103060 entitled “Wireless Communication System, Wireless Communication Method, Wireless Base Station and Wireless Terminal Station”, Japanese Patent Laid-Open No. 2001-144722 entitled “OFDM Transmitting/Receiving System”, Japanese Patent Laid-Open No. 2001-1488678 entitled “Multiple-Carrier Communication System” and Japanese Patent Laid-Open No. 11-55210 entitled “Multiple Signal Transfer Method and System”.

For frequency selectivity fading due to multiple paths, which is a particularly significant problem in data transfer via wireless propagation channels, multiple carrier systems have been proposed, which seek to improve the transfer characteristics by arranging a number of narrow-band carriers one after another on the frequency axis. Among these systems, an orthogonal frequency division multiplexing (OFDM) system, in which carriers are arranged such that these carriers are orthogonal to one another, and a multiple carrier-code division multiple access (MC-CDMA) system, in which sub-carriers are modulated after signal spreading along the frequency axis, have been broadly studied and developed. Here, “Digital Mobile Communication” Tadashi Fuino, Shokodo, 2,000, pp. 170-175, OFDF system, and “Performance of Coherent Multi-Carrier/DS-CDMA for Broadband Packet Wireless Access”, Sadayuki Abeta, IEICE Trans. on Commun., Vol. B84-B, No. 3, March 2001, MC-CDMA system, will be described with reference to FIGS. 6 and 7.

FIGS. 7 and 8 are block diagrams showing an OFDM wireless communication system (transmitter and receiver). This wireless communication system comprises a transmitter 31 (see FIG. 7) and a receiver 41 (see FIG. 8). The transmitter 31 has a base-band signal generator unit 101, a serial-to-parallel converter unit 102, an inverse Fourier transform unit 105 and a guard interval adding unit 106. The receiver 41 has a guard interval removing unit 202, a Fourier transform unit 203, a parallel-to-serial transform unit 206 and a base-band demodulating unit 207.

In the transmitter 31, the base-band signal generator unit 101 receives transmitted signal Sᵢₙ, and outputs symbol time series signal S_{Bmod}. The serial-to-parallel transform unit 102 receives the output signal S_{Bmod} of the base-band signal generator unit 101 for conversion to output parallel signals S_{SP}(1) to S_{SP}(N). The inverse Fourier transform unit 105 receives the output of the serial-to-parallel converter unit 102 to output time series signal SIFFT. The guard interval adding unit 106 receives the output of the inverse Fourier transform unit 105, and outputs signal SGI by partly adding the signal S_{IFFT} which was inversely transformed as a guard interval.

In the receiver 41, the guard interval removing unit 202 receives the received signal Rᵢₙ, and outputs guard interval-removed OFDM signal R_{GID}. The Fourier transform unit 203 receives the OFDM signal R_{GID}, and outputs Fourier transformed signals R_{FFT}(1) to R_{FFT}(N). The parallel-to-serial converter unit 206 receives the parallel signals R_{FFT}(1) to R_{FFT}(N), and outputs time series signal R_{PS}. The base-band demodulator unit 207 receives the time series signal R_{PS}, and outputs signal Rₒᵤₜ. As shown above, in the OFDM system, the transmitted signal is formed by modulating narrow-band sub-carries on the frequency axis and then making inverse Fourier transform of the modulated signal. In the receiver, the received signal is demodulated by transforming the signal with Fourier transform to signal in the frequency axis. By adding the guard interval, it is possible to remove the effects of multiple paths arriving within this time with the orthogonal property of triangular function.

FIGS. 9 and 10 show an MC-CDMA wireless communication system. This wireless communication system comprises a transmitter 5 (see FIG. 9) and a receiver 61 (see FIG. 10). The transmitter 51 has a base-band signal generator unit 101, a serial-to-parallel converter unit 102, a plurality of spreading units 501, an inverse Fourier transform unit 105 and a guard interval adding unit 106. The receiver 61, on the other hand, has a guard interval removing unit 202, a Fourier transform unit 203, a plurality of despreading unit 601, a parallel-to-serial converter unit 106 and a base-band demodulator unit 207.

In the transmitter 51, the base-band signal generator unit 101 receives input signal Sᵢₙ, and outputs symbol time series signal S_{Bmod}. The serial-to-parallel converter unit 102 receives the output signal S_{Bmod} of the base-band signal generator unit 101 for conversion to output parallel signals S_{SP}(1) to S_{SP}(N/SF). The spreading units 501 receives one of the output signals S_{SP}(1) to S_{SP}(N/SF), and output spreaded signals S_{SS}(1) to S_{SS}(N). The inverse Fourier transform unit 105 receives the output signals S_{SS}(1) to S_{SS}(N), and outputs inverse Fourier transformed time series signal S_{IFFT}. The guard interval adding unit 106 m receives the output signal S_{FFT} of the inverse Fourier transform unit 105, and outputs signal S_{GI} by partly adding the signal IFFT as guard interval.

In the receiver 61, the guard interval removing unit 202 receives the signal Rᵢₙ, and outputs guard interval-removed OFDM signal R_{GID}. The Fourier transform unit 203 receives OFDM signal R_{GID}, and outputs Fourier-transformed signals R_{FFT}(1) to R_{FFT}(N). The despreading units 601 receive SF Fourier-transformed signals RFFT for despreading to output signals R_{DSS}(1) to R_{DSS}(N/SF). The parallel-to-serial converter unit 206 receives the parallel signals R_{DSS}(1) to R_{DSS}(N/SF), and outputs time series signal RPS. The base-band demodulator unit 207 receives the time series signal R_{PS}, and outputs output signal Rₒᵤₜ.

As shown above, the MC-CDMA wireless communication system features that the transmitter 51 executes Fourier transform after spreading signal on the frequency axis and that the receiver 61 inversely spreads the Fourier-transformed signal. Thus, interference power can be suppressed on the frequency axis, and it is thus possible to multiplex data of a plurality of users on the frequency axis and, in the case of a cellular system, permit use of the same frequency band.

In the above OFDM wireless communication system, however, although it has excellent anti-multiple-path characteristics, in the case of cellular system construction the characteristics are greatly deteriorated in the cell borderline neighborhood or like place, in which the interference power level is increased. Accordingly, channel allotment techniques such as fixed channel allotment or dynamic channel allotment become necessary. In such cases, the frequency utilization efficiency is reduced, or the control load is increased.

The MC-CDMA wireless communication system, which is less or hardly influenced by the interference power, can maintain high frequency utilization efficiency compared to the case of the cellular system construction. However, in the case of multiplexing data of a plurality of users with spreading codes on the frequency axis of the case code multiplexing for communication speed increase, departure from the orthogonal property is increased due to adverse effects of the frequency selectivity fading, thus resulting in deterioration of the transfer characteristics.

In the above wireless communication systems of the two different types, sufficient transfer characteristics are obtainable in communication in places where sufficient electric field intensity is obtainable. However,in places which are far distant from the base station or in which the electric field intensity is reduced, sufficient received power can not be obtained irrespective of the presence or absence of interference power. Therefore, the transfer characteristics are deteriorated.

### SUMMARY OF THE INVENTION

According to an aspect of the present invention, there is provided a wireless communication system for communication between a transmitter and a receiver in a multiple-carrier system, wherein: the number and disposition of sub-carriers used for communication are adaptedly controlled according to the line quality, a greater number of sub-carriers is selected for communication when the line quality is satisfactory, a less number of sub-carriers is selected for communication when the line quality is unsatisfactory.

The number M (M being an integral number greater than 1 and less than N which is the total sub-carrier number) of sub-carriers is determined for sub-carrier selection under a condition that the line quality in the case of the M sub-carriers satisfies a predetermined line quality, the selected M sub-carriers being used for communication. The number M is determined for the sub-carrier selection under a condition that the line quality in the case of the M sub-carriers satisfies a predetermined line quality after superimposition of the power of the remaining (N−M) sub-carriers, the selected M sub-carriers being used for communication.

N/K (K being a sub-multiple of N) blocks of K continuous sub-carriers are formed and divided into L (L being an integral number greater than 1 and less than N/K) groups for sub-carrier selection, and sub-carriers in the same group are preferentially selected for the sub-carrier selection. The signal power versus interference power ratio is used as the line quality, and higher line quality sub-carriers are preferentially selected for use in the next transmission and reception. The signal power versus noise power ratio is used as the line quality, and higher line quality sub-carriers are preferentially selected for use in the next transmission and reception. The signal power is used as the line quality, higher line quality sub-carriers being preferentially selected for use in the next transmission and reception.

The transmitter comprises, in addition to a base-band signal generator unit, a serial-to-parallel converter unit, an inverse Fourier transform unit, and a guard interval adding unit, these units being connected in succession in the mentioned order, a sub-carrier mapping unit and a power control unit, these units being provided between the serial-to-parallel converter unit and the inverse Fourier transform unit, a multiplexer unit provided on the output side of the guard interval adding unit, and a sub-carrier allotment control unit for outputting signal representing the selected sub-carrier disposition to the serial-to-parallel converter unit, the sub-carrier mapping unit, the power control unit and the multiplexer unit.

The receiver comprises, in addition to a guide interval removing unit, a Fourier transform unit, a parallel-to-serial converter unit and a base-band signal demodulator unit, these units being provided in succession in the mentioned order, a separator unit provided on the input side of the guard interval removing unit, an inverse sub-carrier mapping unit provided between the Fourier transform unit and the parallel-to-serial converter unit, a sub-carrier disposition determining unit provided on the output side of the separator unit.

Other objects and features will be clarified from the following description with reference to attached drawings.

### BRIEF DESCRIPTION OF THE DRAWINGS

FIGS. 1 and 2 are block diagrams showing the construction of a preferred embodiment of the wireless communication system according to the present invention;

FIG. 3 shows a first example of practical application of the wireless communication system shown in FIGS. 1 and 2;

FIG. 4 shows a second example of practical application of the wireless communication system shown in FIGS. 1 and 2 according to the present invention;

FIG. 5 (A)-(C) are drawings for explaining the signals from transmitters A-C from the receiver A and interference shown in FIG. 4;

FIG. 6 (A)-(D) are drawings for explaining the operation of the wireless communication system shown in FIG. 4;

FIGS. 7 and 8 are block diagrams showing transmitter and receiver of a prior art OFDM wireless communication system; and

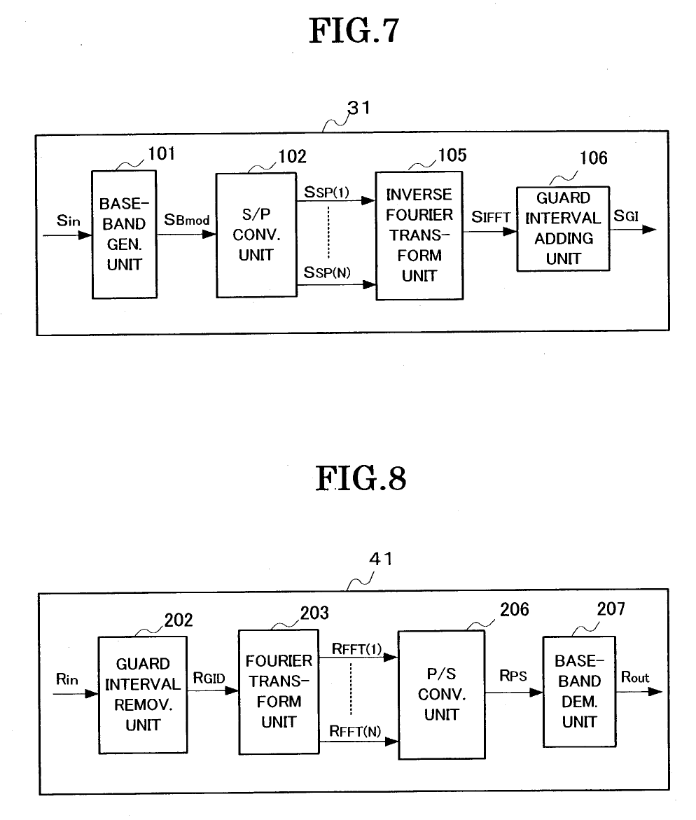

FIGS. 9 and 10 are block diagrams showing transmitter and receiver of a prior art MC-CDMA wireless communication system.

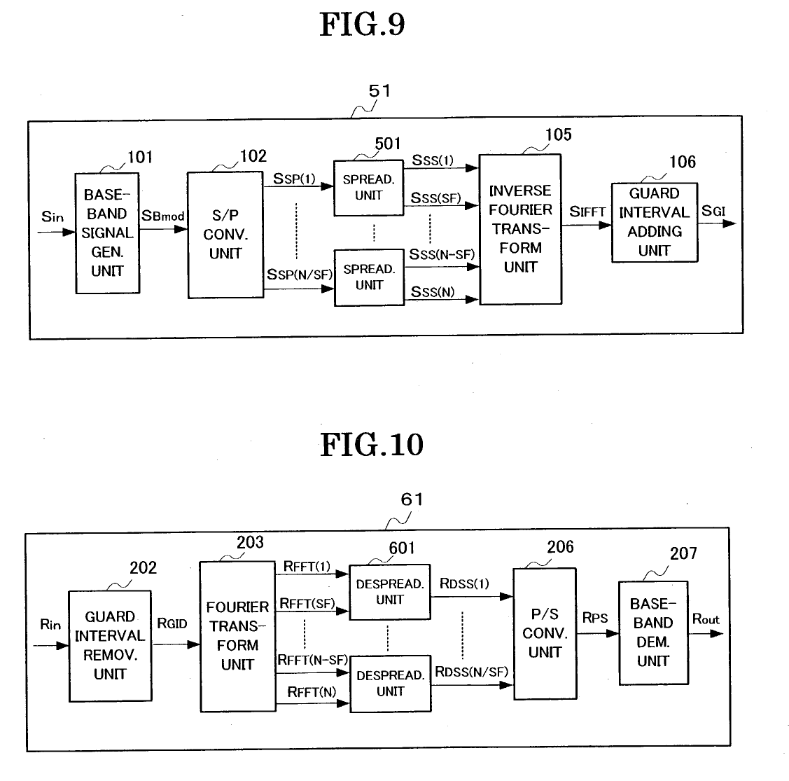

### PREFERRED EMBODIMENTS OF THE INVENTION

Preferred embodiments of the present invention will now be described with reference to the drawings.

For the sake of the brevity of description, constituent elements corresponding to those in the prior art described above, are designated by like reference numerals.

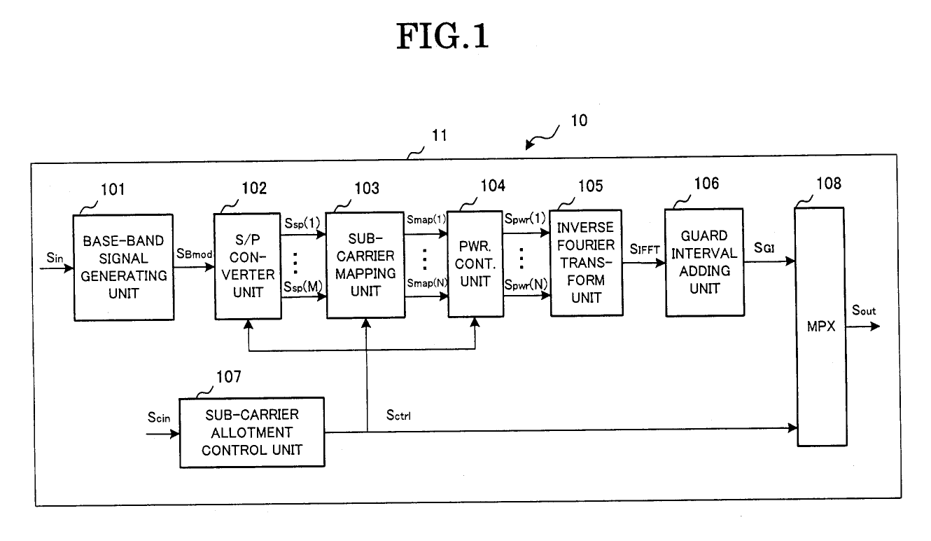

FIGS. 1 and 2 are block diagrams showing the construction of a preferred embodiment of the wireless communication system according to the present invention. This wireless communication system 10 comprises a transmitter 11 (see FIG. 1) and a receiver 21 (see FIG. 2). The transmitter 11 has a base-band signal generator unit 101, a serial-to-parallel converter unit 102, a sub-carrier mapping unit 103, a power control unit 104, an inverse Fourier transform unit 105, a guard interval adding unit 106, a sub-carrier allotment control unit 107 and a multiplexer unit. The receiver 21, on the other hand, has a separator unit 201, a guard interval removing unit 202, a Fourier transform unit 203, a sub-carrier disposition signal reproducing unit 204, an inverse sub-carrier mapping unit 205, a parallel-to-serial converter unit 206, a base-band demodulator unit 207 and a sub-carrier disposition determining unit 208.

In the transmitter 11, the base-band signal generator unit 101 receives input signal Sᵢₙ, and outputs symbol time series signal S_{Bmod}. The serial-to-parallel converter unit 102 receives the output signal S_{Bmod} of the base-band signal generator unit 101 and the output of the sub-carrier allotment control unit 107 for serial-to-parallel conversion based on the number (here M, the maximum value of M being N) of sub-carriers used for transmission, and output M parallel signals S_{SP}(1) to S_{SP}(M).

The sub-carrier mapping unit 103 receives the output of the serial-to-parallel converter unit 102 and the output of sub-carrier allotment control unit 107, and outputs N signals Sₘₐₚ(1) to Sₘₐₚ(N) by allotting the input signals S_{SP}(1) to S_{SP}(M) to the M selected sub-carriers among the N sub-carriers. The power control unit 104 receives the output of the sub-carrier mapping unit 103 and the output of the sub-carrier allotment control unit 107. For increasing the power density of the M selected sub-carriers, the power control unit 104 sets the power density of the (N - M) non-selected sub-carriers to “0”, and superimposes this on the M sub-carriers, thus outputting power-controlled signals S_{pwr}(1) to S_{pwr}(N).

The inverse Fourier converter unit 105 receives the output signals S_{pwr}(1) to S_{pwr}(N), and outputs inverse Fourier-transformed time series signal S_{IFFT}. The guard interval adding unit 106 receives the output signal S_{IFFT} of the inverse Fourier converter unit 105, and outputs signal S_{GI} by partly adding the input as a guard interval. The multiplexer 108 receives the output signal S_{GI} of the guard interval adding unit 105 and the output signal S_{ctrl} of the sub-carrier allotment control unit 107, and outputs, as output signal Sₒᵤₜ, demodulated OFDM signal and signal S_{ctrl} indicative of the selected sub-carriers.

In the receiver 21, the separator unit 201 receives received signal Rᵢₙ, and separates data R_{SC} concerning the number and disposition of the selected sub-carriers and also the demodulated OFDM signal R_{DEMUX} from the received signal. The sub-carrier disposition signal reproducing unit 204 receives the output signal R_{SC} of the separator unit 201, and outputs signal R_{ctrl} representing the disposition of the selected sub-carriers by demodulating the input signal. The guard interval removing unit 202 receives the separated signal R_{DMUX}, and outputs guard interval-removed OFDM signal R_{GID}. The Fourier converter unit 203 receives OFDM signal R_{GID}, and outputs Fourier transformed signals R_{FFT}(1) to R_{FFT}(N). The inverse sub-carrier mapping unit 205 receives the output of the Fourier transform unit 203 and the output of the sub-carrier disposition signal reproducing unit 204, and output signals R_{Dmap}(1) to R_{Dmap}(M) by extracting M modulated sub-carriers.

The parallel-to-serial converter unit 206 receives parallel signals R_{Dmap}(1) to R_{Dmap}(M), and outputs time series signal R_{PS}. The base-band demodulating unit 207 receives the time series signal R_{PS}, and outputs signal Rₒᵤₜ. The sub-carrier disposition determining unit 208 receives the output signal R_{DMUX} of the separator unit 201, estimates the line quality of each sub-carrier, and transmits signal Rₙₑₓₜ representing the result of estimation. When the signal Rₙₑₓₜ is received in the transmitter 11, particularly the sub-carrier allotment control unit 107 therein, it is made to be signal S_{cin}, by some means (for instance transmission and reception in the inverse directions).

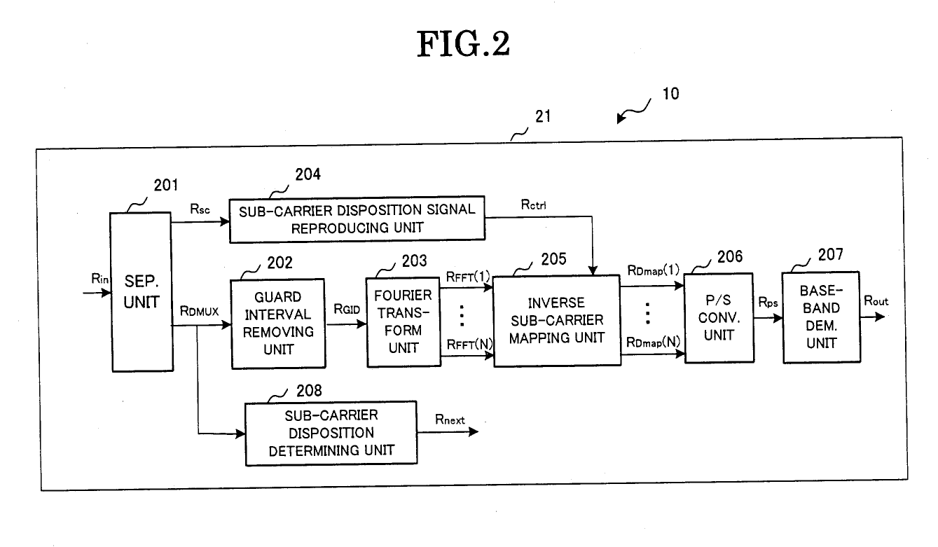

FIG. 3 shows a first example of practical application of the wireless communication system shown in FIGS. 1 and 2. This example comprises a transmitter 11 and two receivers 21a and 21b located in places at different distances d₀ and d₁ from the transmitter 11. Here, for the sake of the brevity only attenuation with distance is considered as variation in the propagation route under the assumption that radio waves are attenuated according to the biquadratic power of the distance. In this case, the received power Pr at a point at distance d is expressed as:

Pr=P_{t·}d^{-α}

where Pₜ represents the transmitted power. In the case of using the OFDM system, denoting the received signal power versus noise power ratio (SNR) per sub-carrier in the receiver 21a at the point at distance d₀ by γ₀, SNR(γ) at the point at distance d₁ is given as:

γ=γ₀(d₁/d₀)^{-α}.

Thus, assuming the necessary line quality to be γ₀, communication satisfying the necessary line quality is obtainable at the point at distance d₀. At the point at distance d1 (d₁/d₀) ^{-α}, however, the SNR of the received signal is reduced to (d₁/d₀) ^{-α} times, and communication satisfying the necessary line quality thus is very difficult.

In contrast, in the case of selecting sub-carriers and making power superimposition with respect to the selected sub-carriers, the SNR of the received signal per sub-carrier is

γ=γ₀(d₁/d₀) ^{-α}N/M

where N is the total sub-carrier number and M (M<N) is the number of the selected sub-carriers. Thus, where the necessary line quality is γ₀, the sub-carrier disposition determining unit 208 in the receiver 21a determines M such as

(d1/d₀)^{-α}N/M≧1.

The determined number M is transmitted to the transmitter 11, and the sub-carrier allotment control unit 107 in the transmitter 11 sequentially selects M sub-carriers among the satisfactory line quality sub-carriers. By so doing, communication satisfying the necessary line quality can be expected. For example, in the case of d₁=2d₀, we have

M≦N/16.

Thus, by using 1/16 of the full sub-carriers, the communication distance can be doubled. Thus, in the case where the transmitter 11 is provided as a base station and the receiver 21 is provided as a terminal, it is possible to provide a wireless communication system having a broader coverage.

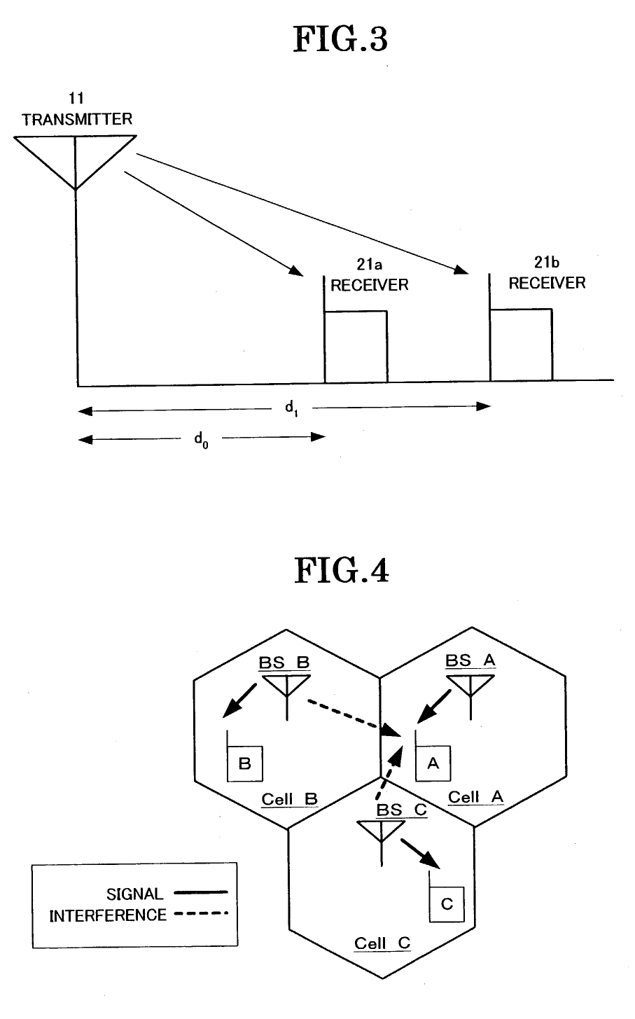

FIG. 4 shows a second example of practical application of the wireless communication system shown in FIGS. 1 and 2 according to the present invention. FIG. 4 actually represents a status that cells having a transmitting function in a base station and a receiving function in a terminal use the same frequency band and inter-connected to run a system. Terminal A is located in the neighborhood of the borderlines between cells A and B and between A and C, and is strongly affected by interference power (shown by dashed arrows) from the base stations B and C. Since the terminal A is located in the inter-cell borderline neighborhood, it is regarded to be substantially at a fixed distance from any base station. Where a transceiver is constructed by using OFDM or like prior art techniques in all the cells, the received power versus interference power ratio (SIR) in the terminal A is at most −3 dB. This is thought to be due to the surpassing of the received power by the interference power, leading to very inferior communication quality.

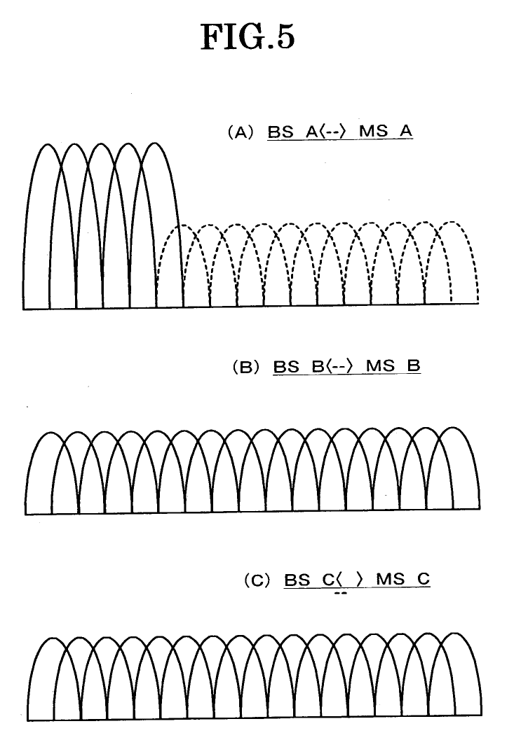

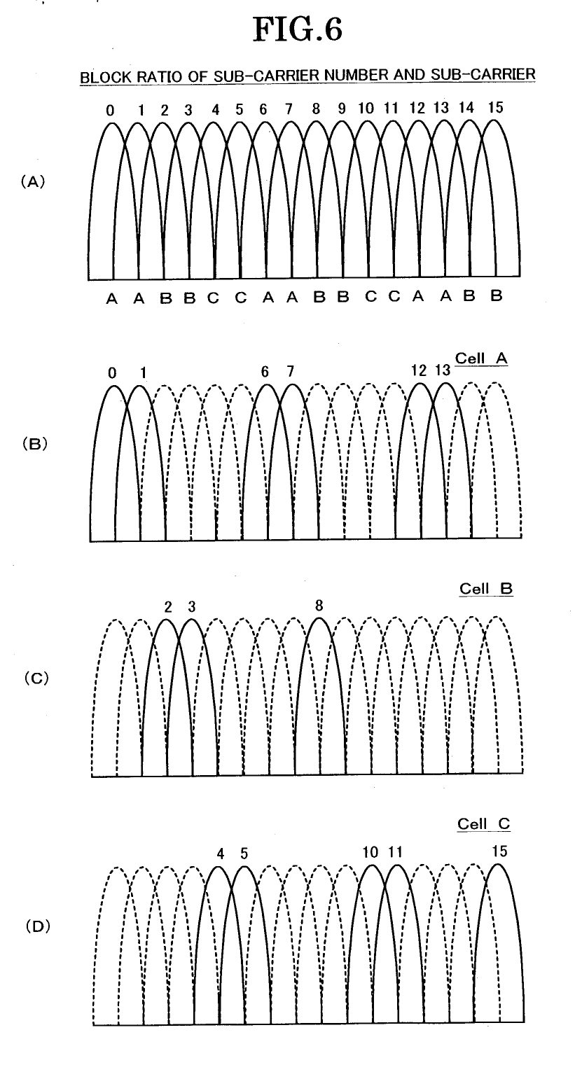

A wireless communication system, which is constructed by using the transmitter 11 and the receiver 21 in the wireless communication system according to the present invention are used in the cell A alone, is operable as follows. Between the base station A and the terminal A, sub-carriers used for the transmission and reception are selected as shown in, for instance, FIG. 5, and superimposition of all power is made with respect to the selected sub-carriers (see FIG. 5(A)). By so doing, the SIR of the received signal is improved by N/M (N being the total sub-carrier number, M being the number of the selected sub-carriers) times, and it is possible to reduce effects of the interference power. Another case will now be considered, in which the transmitter 11 and the receiver 21 in the wireless communication system according to the present invention are used in all cells, the total sub-carriers are grouped in three (L=3) blocks A to C including two (K=2) sub-carriers as shown in FIG. 6, and the cells A to C preferentially use the blocks A to C, respectively. It is assumed that the sub-carrier disposition determining unit 208 in each base station selects sub-carriers used for transmission by taking the interference power into considerations. Consequently, the cell A uses sub-carriers Nos. 0, 1, 6, 7, 12 and 13 (see FIG. 6(B)), the cell B uses sub-carriers Nos. 2, 3 and 8 (see FIG. 6(C), and the cell C uses sub-carriers Nos. 4, 5, 10, 11 and 15 (see FIG. 6(D)). Thus, it is possible to suppress the influence of the interference power to be extremely low, obtain a satisfactory receiving quality and realize communication, in which all the cells A to C use the same frequency band. Besides, since neither dispersing nor inverse dispersing process is used, it is possible to suppress hardware scale increase in the system construction.

As has been described in the foregoing, with the wireless communication system according to the present invention the following pronounced practical effects are obtainable. It is possible to expect communication distance increase by selecting sub-carriers according to the line quality. In the case of the multiple cell construction, by selecting sub-carriers according to the line quality it is possible to reduce the interference power and realize communication, in which all the cells use the same frequency band. In this case, since no spectral spreading techniques are used unlike the prior art, it is possible to suppress the hardware scale increase.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

What is claimed is:

1. A wireless communication system for communication between a transmitter and a receiver in a multiple-carrier system, wherein:
the number and disposition of sub-carriers used for communication are adaptedly controlled according to the line quality, a greater number of sub-carriers is selected for communication when the line quality is satisfactory, a less number of sub-carriers is selected for communication when the line quality is unsatisfactory.

2. A wireless communication system for communication between a transmitter and a receiver in a multiple-carrier system, wherein:
the number and disposition of sub-carriers used for communication are adaptedly controlled according to the line quality, a greater number of sub-carriers is selected for communication when the line quality is satisfactory, a less number of sub-carriers is selected for communication when the line quality is unsatisfactory, the number M (M being an integral number greater than 1 and less than N which is the total sub-carrier number) of sub-carriers being determined for sub-carrier selection under a condition that the line quality in the case of the M sub-carriers satisfies a predetermined line quality, the selected M sub-carriers being used for communication.

3. A wireless communication system for communication between a transmitter and a receiver in a multiple-carrier system, wherein:
the number and disposition of sub-carriers used for communication are adaptedly controlled according to the line quality, a greater number of sub-carriers is selected for communication when the line quality is satisfactory, a less number of sub-carriers is selected for communication when the line quality is unsatisfactory, the number M being determined for the sub-carrier selection under a condition that the line quality in the case of the M sub-carriers satisfies a predetermined line quality after superimposition of the power of the remaining (N−M) sub-carriers, the selected M sub-carriers being used for communication.

4. The wireless communication system according to claim 1 or 2, wherein N/K (K being a sub-multiple of N) blocks of K continuous sub-carriers are formed and divided into L (L being an integral number greater than 1 and less than N/K) groups for sub-carrier selection, and sub-carriers in the same group are preferentially selected for the sub-carrier selection.

5. The wireless communication system according to one of claims 1 to 4, wherein the signal power versus interference power ratio is used as the line quality, and higher line quality sub-carriers are preferentially selected for use in the next transmission and reception.

6. The wireless communication system according to one of claims 1 to 4, wherein the signal power versus noise power ratio is used as the line quality, and higher line quality sub-carriers are preferentially selected for use in the next transmission and reception.

7. The wireless communication system according to one of claims 1 to 4, wherein the signal power is used as the line quality, higher line quality sub-carriers being preferentially selected for use in the next transmission and reception.

8. The wireless communication system according to one of claims 1 to 4, wherein:
the transmitter comprises, in addition to a base-band signal generator unit, a serial-to-parallel converter unit, an inverse Fourier transform unit, and a guard interval adding unit, these units being connected in succession in the mentioned order, a sub-carrier mapping unit and a powr control unit, these units being provided between the serial-to-parallel converter unit and the inverse Fourier transform unit, a multiplexer unit provided on the output side of the guard interval adding unit, and a sub-carrier allotment control unit for outputting signal representing the selected sub-carrier disposition to the serial-to-parallel converter unit, the sub-carrier mapping unit, the power control unit and the multiplexer unit.

9. The wireless communication system according to one of claims 1 to 4, wherein:
the receiver comprises, in addition to a guide interval removing unit, a Fourier transform unit, a parallel-to-serial converter unit and a base-band signal demodulator unit, these units being provided in succession in the mentioned order, a separator unit provided on the input side of the guard interval removing unit, an inverse sub-carrier mapping unit provided between the Fourier transform unit and the parallel-to-serial converter unit, a sub-carrier disposition determining unit provided on the output side of the separator unit.
